(19) United States
(12) Patent Application Publication
(10) Pub. No.: US 2022/0012154 A1
(43) Pub. Date: Jan. 13, 2022

(54) PROCESS OPTIMIZATION BASED ON USER BEHAVIOR

(71) Applicant: GENERAL ELECTRIC COMPANY, Schenectady, NY (US)

(72) Inventors: Jeremy M. FILIATRAULT, Providence, RI (US); Saurav BANERJEE, Bangalore (IN)

(21) Appl. No.: 16/925,440

(22) Filed: Jul. 10, 2020

(51) Int. Cl. G06F 11/34; G06F 9/451; G06F 40/174

(52) U.S. Cl. CPC G06F 11/3414; G06F 9/453; G06F 11/3447; G06F 11/3438; G06F 40/174

(57) ABSTRACT

Provided is a process optimization engine that can identify pain points within a workflow process based on user behavior within the process. The process optimization engine may also make suggestions to improve the user experience within the process. In one example, a method may include storing user behavior of a target process over time, the user behavior comprising actions made by a user during the target process, identifying a user action within the target process that negatively effects a cycle time needed to complete the target process based on the stored user behavior, determining a suggestion to improve the cycle time of the target process based on rules generated from user behavior within other processes, and outputting a notification of the determined modification.

### BACKGROUND

A workflow is an orchestrated and repeatable process in which a piece of work passes through a plurality of steps. Workflows may be used for activities such as transforming materials, providing services, processing information, and the like. Workflows are commonly used in manufacturing. For example, in a manufacturing shop, a workflow may include a flow of a product or a part through different processing stations. As another example, in robotic process automation, a software robot can be programmed to do basic tasks across applications just as humans are capable of doing such tasks.

However, the developers/owners of the workflow often lack visibility into the performance of the workflow. As a result, it can be difficult for an organization to understand problems (pain points) within a process, identify which points are most affecting the overall process, identify which points are affecting user experience, or how to fix these problems. In many cases, a significant amount of time is spent collecting data manually and analyzing it to make a best-guess on how to change the workflow. However, these guesses often fail to improve the workflow because they are focused on the wrong aspects.

### SUMMARY

The example embodiments improve upon the prior art by providing a system which can collect user behavior within a workflow process, analyze the user behavior, and suggest improvements to the process steps to improve cycle time, the user experience, and the like. The system may identify a root cause or causes of an underperforming workflow based on user behavior, and provide effective remedies based on the user behavior. That is, rather than monitor the performance of the workflow alone, the system described herein monitors the behavior of the users when performing the workflow. For example, the system may monitor and track different user actions and requests within a process such as an end user sending back a request, an end user forwarding a request to another, an end user approving a request, an end user rejecting a request, a save operation, and the like. The system can identify which steps of the workflow are negatively affecting the process based on the user behavior at these steps. Furthermore, a rules engine can be used to provide solutions to improve a step thereby improving the overall process time, user experience, etc.

According to an aspect of an example embodiment, a computing system may include a storage configured to store user behavior of a target process over time, the user behavior comprising selections entered during the target process via a user interface, and processor configured to identify a user behavior within the target process that negatively effects a cycle time needed to complete the target process based on the stored user behavior, determine a suggestion to improve the cycle time of the target process based on rules generated from user behavior within other processes, and output a notification of the determined suggestion.

According to an aspect of another example embodiment, a method may include storing user behavior of a target process over time, the user behavior comprising selections entered during the target process via a user interface, identifying a user behavior within the target process that negatively effects a cycle time needed to complete the target process based on the stored user behavior, determining a suggestion to improve the cycle time of the target process based on rules generated from user behavior within other processes, and outputting a notification of the determined modification.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a computing environment for optimizing a target process in accordance with an example embodiment.

FIGS. 2A-2E are diagrams illustrating examples of a target process and a user interface providing process optimization data in accordance with an example embodiment.

FIG. 3 is a diagram illustrating a comparison of process results before and after changes in accordance with example embodiments.

FIG. 4 is a diagram illustrating a method of determining optimizations for a process based on user behavior in accordance with an example embodiment.

FIG. 5 is a diagram illustrating a computing system for use in the examples herein in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

How users behave within a workflow (also referred to herein as a process) can greatly affect the overall cycle time of the workflow. By controlling user behavior, the example embodiments can dramatically improve the cycle time of the workflow. Examples of user behavior that are performed within a workflow include, but are not limited to, an approval request, a denial, a send back, a forward request to another user, a save operation, and the like.

Many of these user actions may be entered by the user into a user interface in which the workflow is being performed. The amount and/or the frequency of these requests can slow down the process resulting in lack of efficiency. For example, if a process results in too many approval requests, the overall cycle time of the process may be slower than needed. As another example, when too many denials are being issued, there may be problems with the instructions within the workflow.

The example embodiments are directed towards a system which can track and monitor user behavior within a workflow, and identify ways to optimize the workflow to improve the overall cycle time and user experience. For example, the system can track which inputs, requests, button presses, selections, enter commands, etc., are made by a user (e.g., within a user interface, etc.) The system may monitor workflow processing over a predetermined period of time such as days, weeks, months, etc. During this time, user behavior of many different users interacting with the workflow may be tracked and recorded. Furthermore, metrics may be performed on the steps within the process to determine the overall cycle time and the individual step times. The system may store a rules engine which can identify solutions to fix identified problems (e.g., steps that are causing a slow down). For example, the rules engine may provide solutions which improve the user behavior (i.e., by requiring less approval requests, denials, send backs, forwards, etc.), by reducing the amount of fields on a form, and the like. The system may also provide links to external materials to help improve the workflow process.

The system may also provide the results of the workflow process analysis within a user interface. Here, a user may see the metrics of the workflow process on a step-by-step basis, which helps the user understand which steps are causing the problems. For each step, the system may generate suggestion on what to consider, how to make changes to optimize the user behavior, and the like. In addition, the system may also collect user feedback of users interacting with the workflow process. The system may analyze the user feedback and use the feedback to make additional suggestions to improve the user's experience.

The system described herein may be implemented within a workflow management application which provides process owners with the ability to create new workflow processes and modify existing workflow processes. The workflow management application may provide the user with a user interface and a navigation panel, buttons, or the like, which the user can use to navigate through the workflow optimization analysis.

The system may store the tracked data along with metrics that are determined from the track data. During operation, a user may access the system and select a process to run for optimization. The system may ask the user for a previous period of time to be used for the optimization. For example, the user may choose the last month, last week, etc. In response, the system may pull all data of the process from that selected period of time and return information almost instantaneously to the user. Here, the information may include user behavior analysis, cycle time analysis, form input analysis, and the like. The system may highlight or otherwise indicate to the user (e.g., via marks, shading, highlights, etc.) steps of the process that are slower than they should be.

In addition to providing the metrics, the user may also be provided with suggestions for modifying the process in some way. For example, the suggestions may include which steps are more important, what aspects of the step are causing the delay, suggested recommendations on improving he user behavior, and the like. The system may also include a fix button or other option that enables the user to take action. When the fix button is selected, the user may be able to make changes to the workflow via the system. For example, the user may modify approval criteria, remove fields from a form, change an order of steps, change send back criteria, and the like. Thus, the system can provide the user with suggestions that can be implemented into the process in real time.

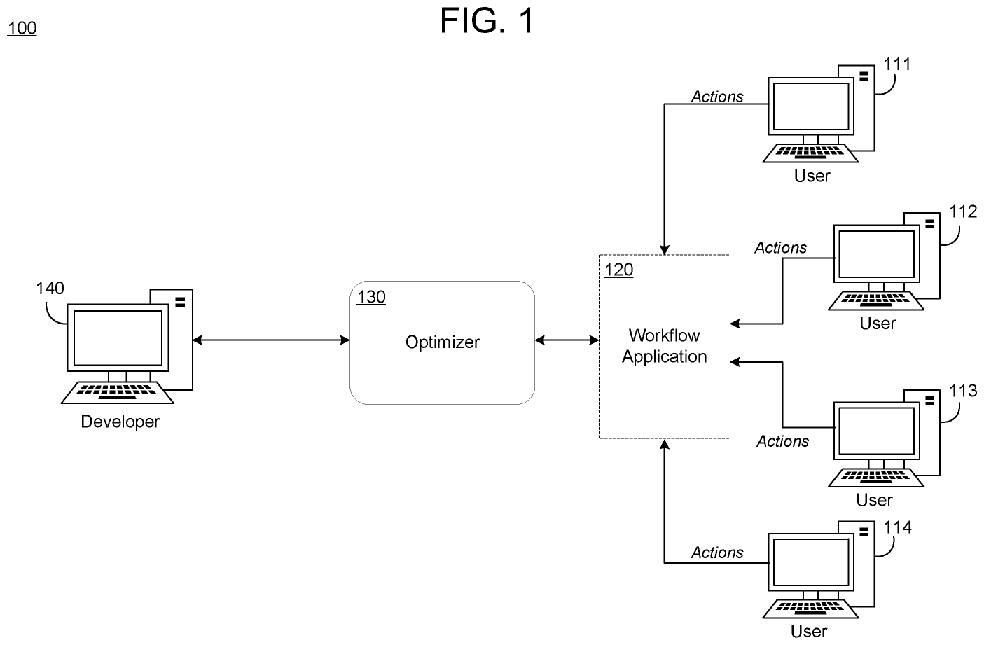

FIG. 1 illustrates a computing environment 100 for optimizing a target process in accordance with an example embodiment. Referring to FIG. 1, the computing environment includes a workflow application 120 which may be hosted on a host platform (not shown) such as a web server, a cloud system, a database, an on-premises server, and the like. In this example, a plurality of user devices 111, 112, 113, and 114 enable users to interact with various processes within the workflow application 120. As a non-limiting example, the workflow application 120 may be a manufacturing-based application for use in manufacturing goods. However, embodiments are not limited thereto. Each of the user devices 111-114 may connect to the host platform that hosts the workflow application 120 via a network such as the Internet.

According to various embodiments, the computing environment 100 further includes an optimizer 130 capable of optimizing processes within the workflow application 120 based on user behavior of users (via the user devices 111-114) interacting with the processes within the workflow application 120. For example, the optimizer 130 may include a code, program, module, service, application, or the like, which is running on the same host platform that hosts the workflow application 120. As another example, the optimizer 130 may be integrated within the workflow application 120. As yet another example, the optimizer 130 may be hosted on a separate computing system (not shown).

The optimizer 130 may monitor and track user behavior of the user devices 111-114 when performing the processes of the workflow application 120. For example, the optimizer 130 may continuously monitor the user behavior such as approval requests, denials, forward requests, send backs, save operations, and the like, which are performed by users when interacting with different processes within the workflow application 120. The optimizer 130 may store the user behavior on a process-by-process basis thereby identifying specific user behavior for each target process. For example, the workflow application 120 may include a first process for refund processing, and a second process for late fee approval. Here, the optimizer 130 may monitor user behavior within each process separately and store the data separately. Thus, when a user wants to optimize the refund processing process, the optimizer may look-up only data from the refund processing process.

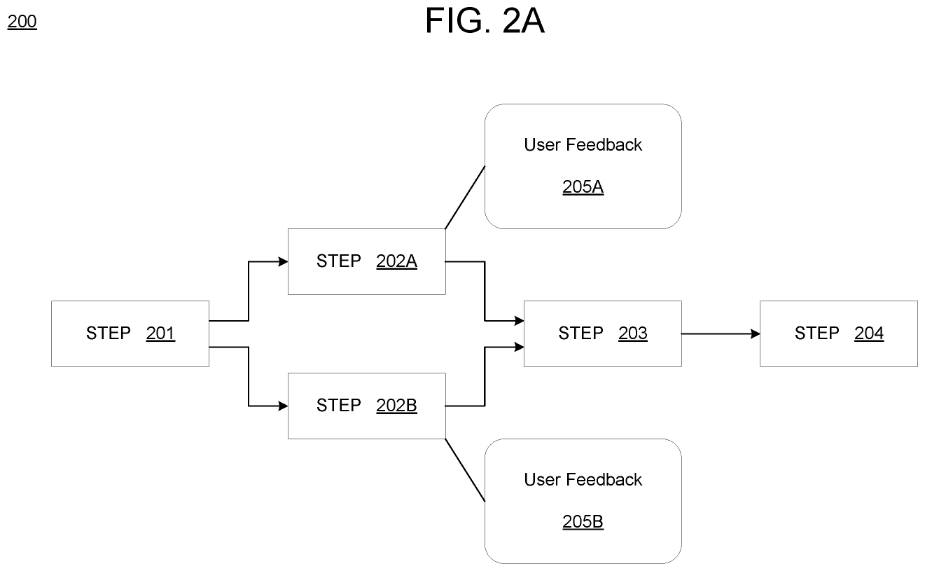

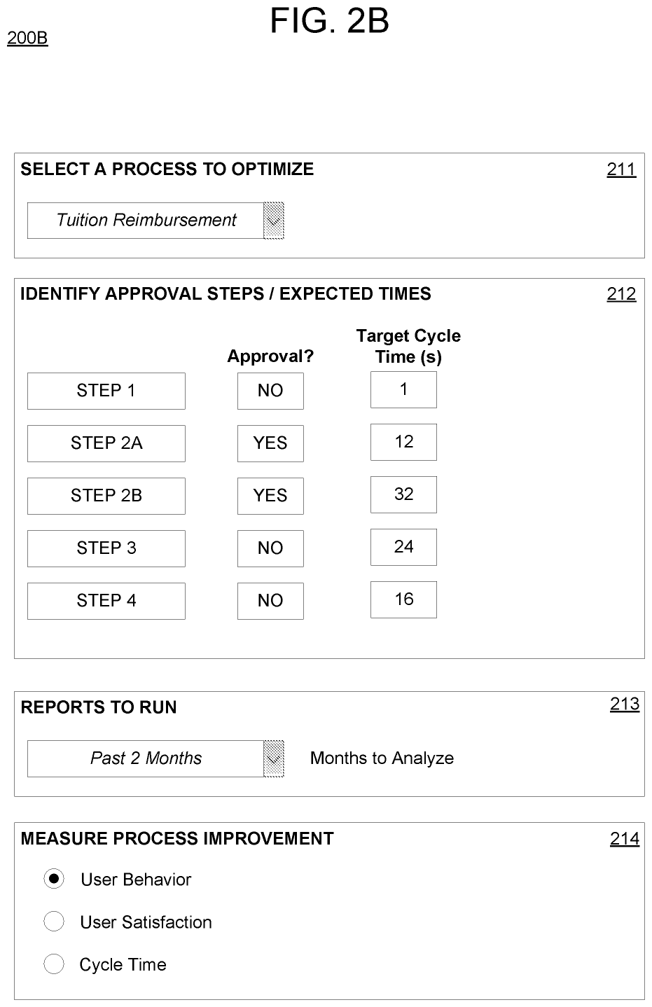

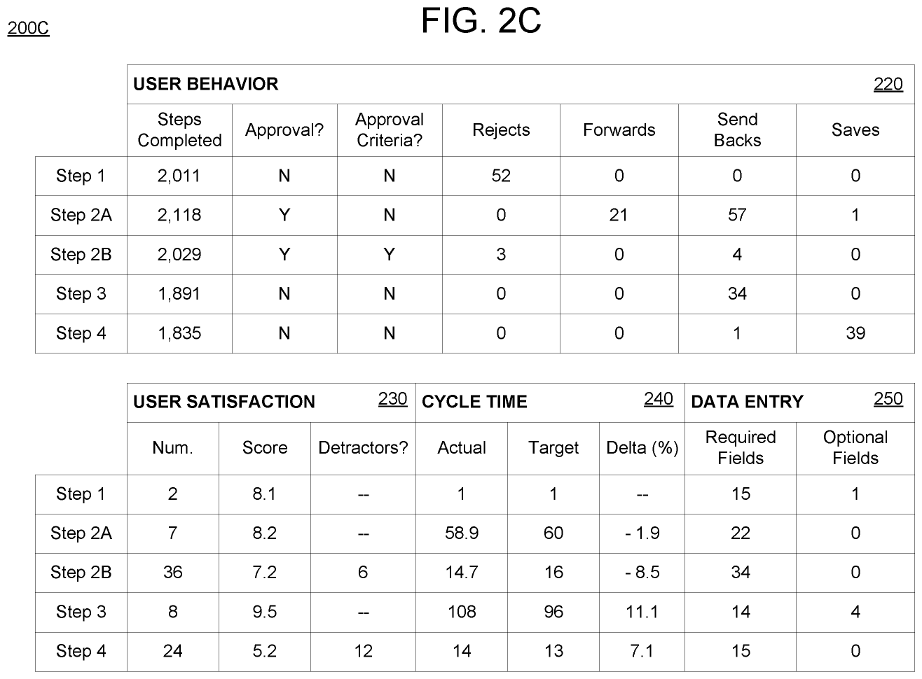

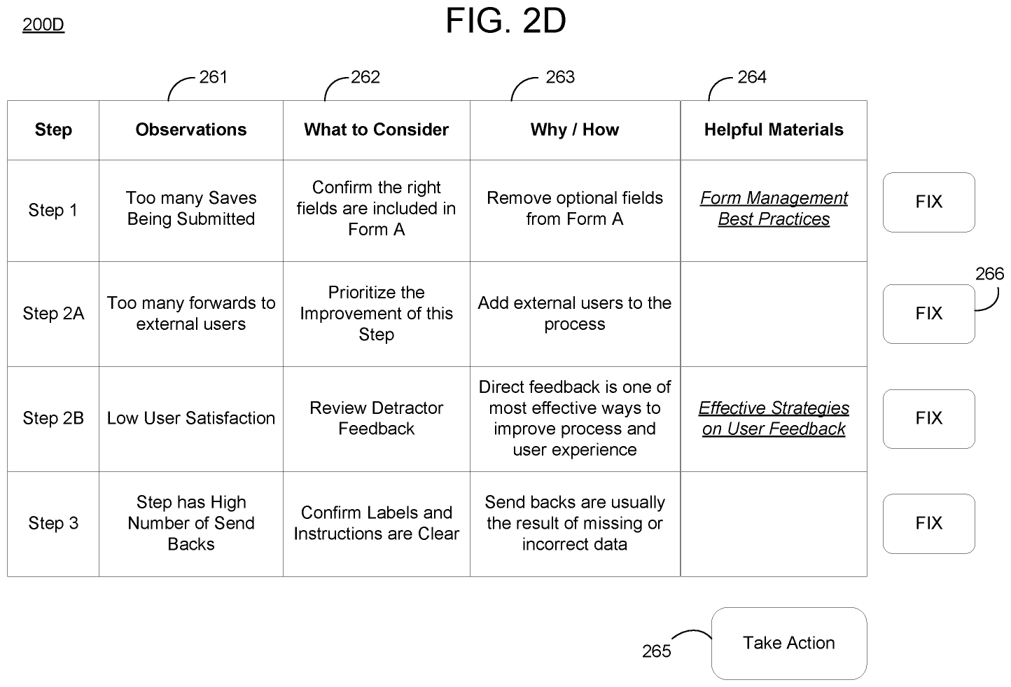

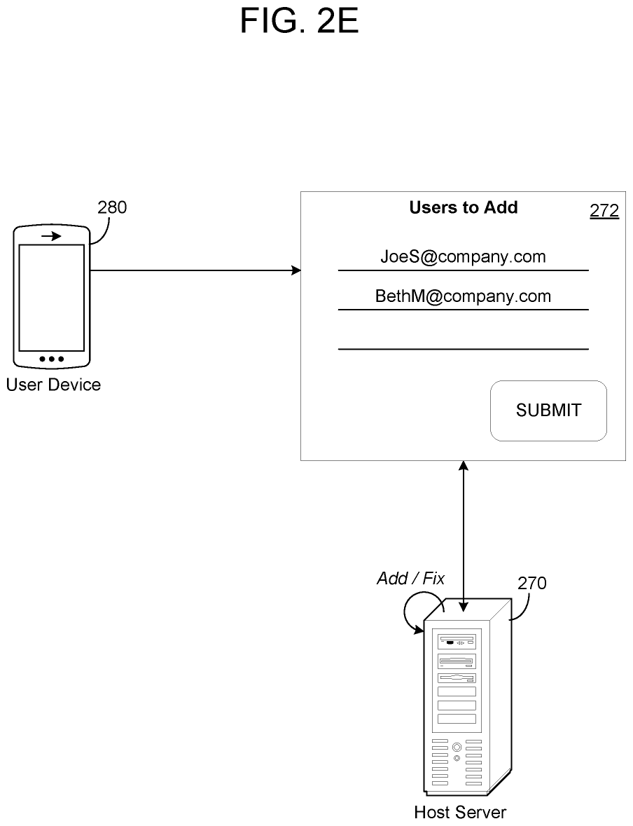

A developer 140 may represent a process owner. Here, the developer 140 may be a workstation of a code developer of a target process within the workflow application 120. As further described in the examples of FIGS. 2A-2D, the optimizer 130 may display a user interface which the developer 140 can view user behavior data from the workflow application 120, as collected by the optimizer 130. Furthermore, the developer 140 may make changes to fix issues/problems within a target process of the workflow application 120 via the user interface provided by the optimizer 130. The optimizer 130 may also provide the developer 140 with metrics before and after changes are made to the target process thereby showing the developer 140 whether improvements were made, and if so, how much the target process improved.

The optimizer 130 may include a data store that is attached thereto or which the optimizer 130 is connected to via a network. The following information may be recorded in the data store each time end-users click on a button in a workflow process:

1) Date/Time of the button click

2) End-User who clicked the button

3) The type of button clicked (Forward, Send Back, Approve, Submit, Reject, etc.)

All click events may be logged and an aggregate assessment may also be performed by the software logic of the optimizer to determine:

1) The count of times the different type of buttons are clicked in a given time span.

2) The % of times the different types of buttons are clicked.

3) The number of fields on the form (amount of data entry)

4) The satisfaction score of users completing the form

5) The average cycle time of completing the form

The information related to the user behavior may be processed by a rules engine and specific recommendations may be delivered to the user and organized based on priority of the improvement opportunity available (e.g., low, medium, high, etc.). The example embodiments are unique in that the system can capture specific user behavior to a workflow process and then analyzes the user behavior to determine the most likely effective change to improve user experience and cycle time. Examples of the user behavior that may be captured include a send back (e.g., an end-user sending back a request in a process), a forward (e.g., an end-user forwarding a request to another person), an approval (e.g., an end-user approving a request), a rejection (e.g., an end-user rejecting a request), a submit (e.g., an end-user submitting a request to the next person in the workflow process), and the like. The requests may be entered via a user interface of a software workflow tool.

The optimizer 130 may analyze the user behavior and create performance metrics such as the number of times each behavior is performed per step of a process, a percentage of cycles which include the behavior, and the like. The optimizer 130 may also factor in other aggregated data points such as the number of form fields, cycle time, etc. This enables the optimizer 130 to get a robust assessment of what is going on in a workflow process and what it means. Besides the methods being used, the outcome of the optimizer 130 may include a specific set of improvement opportunities, grouped by priority.

The example embodiments provide process owners with visibility and data to understand the pain points in a process, rank the pain points, and identify activities to most effectively fix negative user experience. The result is that a lot of time is not wasted collecting data and analyzing it manually. Furthermore, the interface may enable users with specific actions that can be taken to fix the pain points within the process.

The optimizer 130 may automate the collection and analysis of data related to user behavior in a process and the time spent on steps in a process (cycle time). The optimizer 130 may accurately pinpoint where slowness in the process exists and provide improvements for more effective action. The rules used for optimizing the process may be based on many different processes which have been analyzed over time. Typically, a process owner would not have intimate insights into many other processes. The rules provide a database of knowledge of over the different processes and pain points and remedies and the ability to instantly access it and provide a detailed action plan that solves the problem.

For example, the optimizer 130 may access a database of predefined recommended actions that are based on conditions being detected within the steps of a process. The actions paired with conditions are referred to herein as rules. When the optimizer 130 detects a condition, it can trigger the corresponding action paired therewith by evaluating the predefined rules in the database. The database may be built from research of user behavior done on workflows and correlations with user satisfaction, increased cycle time, increased labor time, and the like. For example, a correlation test may determine that more than 30 fields on a form causes a sudden decrease in user satisfaction. As another example, a form having a save rate that reaches more than 10% correlates to a sudden decrease in user satisfaction and increase in cycle time.

Some non-limiting examples of conditions and corresponding actions include a condition of too many rejections (e.g., greater than a predetermined threshold of X) being detected within a step of the process. In this example, the action paired with the condition may be a suggestion to more clearly define the instructions within the process (e.g., on forms, user interfaces, etc.). As another example, a condition may include too many forwards (e.g., greater than a predetermined threshold of X) being performed within a step of the process. In this case, the recommend actions may be to add the external users to the internal workflow group so that forwards are no longer necessary. As another example, a condition may include too many saves being detected when the user's fill out a form. In this example, the corresponding action may be to remove fields from the form, remove optional fields from the form, and the like.

To implement the rules, the optimizer 130 may analyze a process by collecting user actions within the process such as forwards, saves, send backs, rejections, and submits. When the optimizer 130 detects that one of these user actions within the process triggers a condition within the rules, the optimizer 130 may apply a predefined action paired with the detected condition and output the suggested action as a recommendation for modifying the process. The example embodiments introduce a novel approach to enhancing cycle time and user satisfaction within a process by collecting and analyzing user interaction with the process.

The example embodiments provide both technical and commercial advantages of not requiring the input and assumptions of a single person or small group of people. The human subjectivity is removed with the optimizer. It has no biases. It accesses conditions occurring in many other processes, and provides proven remedies. The remedies have been proven effective by measuring before and after results of actions taken on pain points. All a process owner needs to do is click a button and whatever is happening in their process that is not desirable (as determined by other processes being improved when fixed) is identified and a proven, very specific solution provided. In short, the commercial advantage is that no action/thinking is necessary by a process owner to understand exactly where improvement is needed and how to resolve it. Unlike other tools, the user may simply click a button and the analysis is complete and the corrective action provided is specific and highly effective.

FIGS. 2A-2E illustrate examples of a target process and a user interface providing process optimization data of the target process in accordance with an example embodiment. Referring to FIG. 2A, an example of a process 200 is shown with a plurality of steps including steps 201, 202A, 202B, 203, and 204. The process 200 is a simple example of a flow within a workflow application that may be performed. It should be appreciated that a process may be significantly more complex, but is shown simply here for convenience of explanation. In this example, the first step 201 in the process 200 corresponds to a beginning/start of the process 200 and the last step 204 corresponds to the end of the process 200. Each time a user goes from the first step 201 to the last step 204 is considered a cycle of the process 200. Furthermore, the process 200 includes two parallel steps 202A and 202B. The parallel steps 202A and 202B may be optional, required, etc.

In addition, the process 200 also includes windows 205A and 205B that enable users of the target process to provide feedback. The feedback may include text content that describes the opinions of the user. Here, the windows 205A and 205B allow users the ability to provide a description of issues they are experiencing during the steps of the process. The optimizer may display the feedback modules 205A and 205B within a console, user interface, etc., that is provided by the optimizer.

FIG. 2B illustrates an example of a user interface 200B which can be output by the optimizer 130 shown in FIG. 1. The user interface 200B may be included within a workflow management application, etc. Referring to FIG. 2B, the user interface 200B includes a process selection module 211 that allows a user to specify a target process from within a workflow application that may include dozens of other processes. In this example, the user selects the process 200 shown in FIG. 2A that corresponds to tuition reimbursement process. In response, the user interface 200B may display an approval and target time module 212 which includes a list of steps within the process along with a button for indicating whether the step includes an approval or not. It should be appreciated that while a user may label the individual steps as approval steps or not, using the approval and target time module 212, in other examples, the system may automatically detect which steps within a target process have approvals. Furthermore, the approval and target time module 212 may include input fields that allow the user to predefine a target cycle time for each step of the process. The target cycle time is the target completion time from start to finish of the respective step.

The user interface 200B further includes a reports to run module 213 that allows a user to select historical process data to be used for optimization. Here, the optimizer may continuously store process data over time. Thus, when a user desires to optimize a process, the user simply selects a period of data that has been previously captured, and runs optimization based thereon. In this example, the user selects the last two months of process data. Accordingly, the user may test a process in real time using user behavior data of the process that has been previously captured and processed by the optimizer.

The user interface 200B further includes an optimization module 214 which allows the user to select a specific type of optimization to perform, for example, user behavior optimization, user satisfaction optimization, cycle time optimization, and the like. The user behavior optimization and the cycle time optimization may be based on the user actions within the target process. The user satisfaction optimization may be based on the feedback provided by users of the target process.

FIG. 2C illustrates a user interface 200C showing examples of monitoring results of the target process over the last two months. Referring to FIG. 2C, the user interface 200C includes a tabular format of rows and columns that make up cells/fields of data. For example, a user behavior module 220 includes values of actions/behavior that are taken during each step, and also identifies a number/amount of times the steps were performed. The user behavior module 220 includes values indicating whether the step includes an approval, whether the approval has criteria, a number of rejections that occur during the step, a number of forwards that occur during the step, a number of send backs that occur during the step, and a number of saves (of a form) that occur during each step.

The user interface 200C also includes a user satisfaction module 230 which includes values for a number of feedbacks that are left, an average score, and whether the feedback provided detractors. The user interface 200C also includes a cycle time module 240 which includes values for actual cycle time as measured by the optimizer, a target cycle time that is predefined, a delta (difference) between the actual and the target, and the like. The user interface 200C also includes a data entry module 250 which includes values identifying a number of fields of a form that is filled-in during the step, a number of optional fields in the form, and the like. Through the user interface 200C, the optimizer can show a user/owner of a target process the metrics of each step, and the overall metrics of the process. Thus, a user can quickly see where the problems lie within their process.

FIG. 2D illustrates a user interface 200D which provides example optimization suggestions to the owner/user of the target process. Referring to FIG. 2D, the user interface includes another tabular representation with columns and rows providing possible optimization data to consider. In the example of FIG. 2D, the user interface 200D includes an observation field 261 which provides an observation about why the step may be slow or below expected timing. The user interface 200D further includes a what to consider field 262 that may provide the user with insight into the importance of the step, which aspect of the step is critical, etc. The user interface 200D also includes a why or how field 263 which provides information about why optimization is important, how to perform the optimization, and/or the like. The what to consider field 262 may include suggested actions to take in order to improve the cycle time, user satisfaction, etc. of the step. The why or how field 263 may specify which particular action to take. The user interface 200D also includes a helpful materials field 264 that provides links to external reference information that can help train and provide optimization insight to the user. It should be appreciated that the user interface 200D may include different suggestions or recommendations than shown, and that the example of FIG. 2D is not meant to limit the embodiments.

In some embodiments, the user interface 200D may include a fix button which a user can select to immediately optimize a step of the process. For example, the fix button may enable a user to remove fields from a form, modify/update criteria for an approval, improve labels on a document or interface, and the like. The type of actions that are provided to the user may depend on the situation including the type of fix/recommendation suggested by the system. In response to the fix button being selected, for example, a user may be provided with another window where user inputs can be processed by a host server (e.g., host server 270 shown in FIG. 2E) which includes logic for implementing the changes in real time.

In the example of FIG. 2D, the user press a fix button 266 which directs the user to the user interface 200E shown in FIG. 2E where a user is provided with options to add external users to the process to fix/improve step 2A of the target process based on the recommendations provided by the system. In this example, the step 2A is determined to be slow because of an amount of forward requests being sent to users outside the target process. When the user clicks the fix button 266 shown in FIG. 2D, the host server 270 may output a user interface 200E which asks the user to enter names/contact information of external users to be added to the step/process via an input window 272. Using a user device 280, the user may submit contact information of the external users and hit a submit button. In response, the host server 270 may include logic to upgrade process/workflow and add the submitted users into the roll member field of the process. The host server 270 may include logic that can run or otherwise make changes to the process software behind the scenes to add the users to the member field of the target process. In doing so, the target process may become more efficient since notifications can be provided by the host server 270 directly to the users that are now members of the process rather than relying on users to communicate with external users outside of the target process.

In addition, the user interface 200D (or any of the other user interfaces 200B or 200C) may include a take action button 265, or some other selectable option to improve or otherwise fix the optimization of the target process. In this example, the user may select the take action button 265 in FIG. 2D and be provided with a user interface allowing the user to make changes to the target process (not shown). For example, the user may manipulate/modify various aspects of the target process including, but not limited to, removal of an approval, rejection, forward, send back, submission, etc. As another example, the user may manipulate the criteria for an approval, a forward, a send back, etc. As another example, the user may manipulate the fields on a form including removing optional fields, etc.

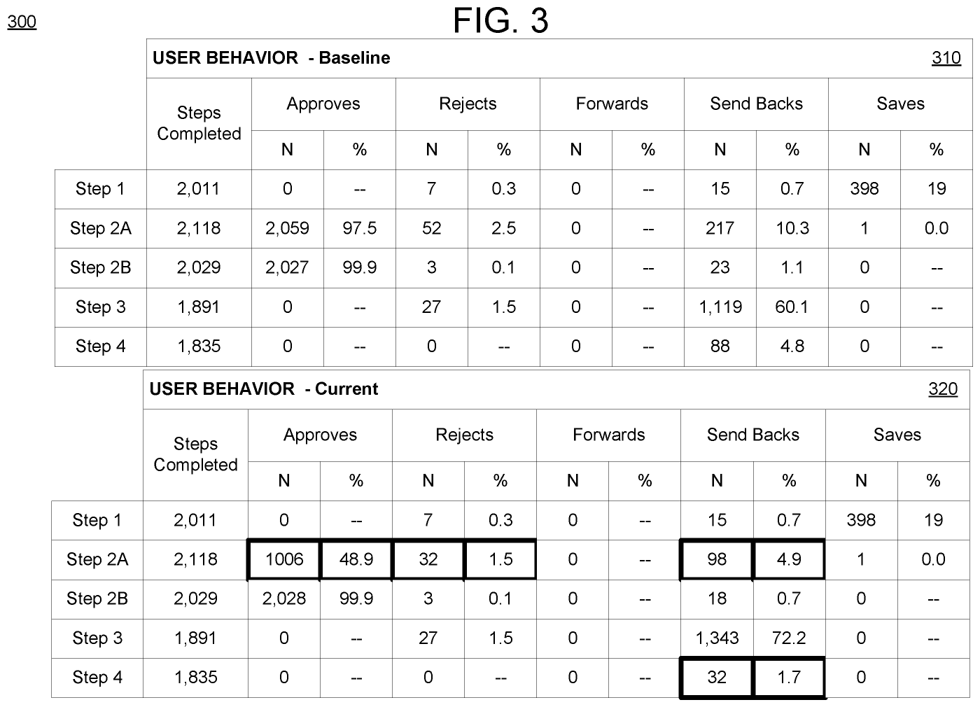

Once the user makes changes to the target process, they may test the target process again. The results of the test are shown in FIG. 3. Here, a user interface 300 includes baseline metrics window 310 with values of user behavior which represents the user behavior prior to the changes being made the by the user. In addition, the user interface 300 further includes a current metrics window 320 with values/metrics of user behavior after a change to the target process has been made. The optimizer may also highlight any changes in the data to help show the optimization. In this example, the optimizer highlights the fields of approves, rejects, and send backs of STEP 2A since these values have changed the most. Here, the optimizer may highlight values if they change in either direction (better or worse) by a predetermined number, percentage, or the like. Thus, the user can quickly see how their changes affected the overall process.

The testing may be performed based on the same data that was used to test the baseline data. The system may remove or otherwise modify the behavior data based on the changes made to the target process by the user.

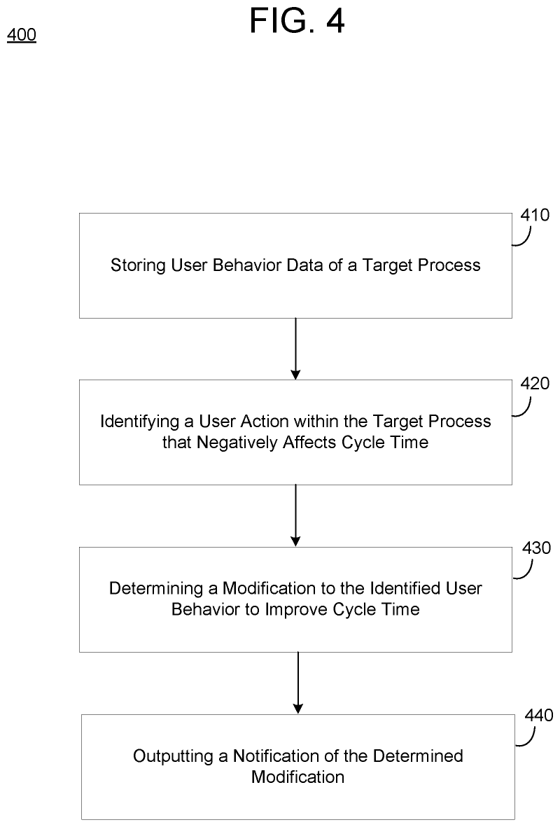

FIG. 4 illustrates a method 400 of determining optimizations for a process based on user behavior in accordance with an example embodiment. For example, the method 400 may be performed by a service, an application, a program, or the like, which is executing on a host platform such as a database node, a cloud platform, a web server, an on-premises server, another type of computing system, or a combination of devices/nodes. Referring to FIG. 4, in 410, the method may include storing user behavior of a target process over time, the user behavior comprising actions made during the target process. The user behavior may include requests or selections entered within a user interface of a workflow process/application. The examples of such requests include approve, reject, forward, send back, save, and the like. In some embodiments, the storing may include monitoring and tracking different requests that are entered via the user interface during a plurality of cycles of the target process, and performing metrics on the different requests to identify points in the process that are slow as a result of user interactions with the process.

In 420, the method may include identifying a user behavior within the target process that negatively effects a cycle time needed to complete the target process based on the stored user behavior. For example, the method may include detecting one or more steps within the process that have a longer than expected processing time, wait time, approval time, etc. Here, the expected processing time may be input by the user within a predefined field (e.g., FIG. 2B) for target cycle time. As another example, the method may include detecting one or forms within the process that require more saves than expected, which indicates a form is too lengthy or improperly worded. In this example, the expected number of saves may be predefined within the rules of the optimizer and may be learned from correlation testing between user satisfaction and number of saves and/or cycle time.

In 430, the method may include determining an action to improve the cycle time of the target process based on rules generated from user behavior within other processes. For example, the action may be paired with a particular condition associated with a user actions within the process (e.g., saves, form fields, send backs, rejects, forwards, submits, etc.) Further, in 440, the method may include outputting a notification of the determined modification. The rules may be provided from a rules engine which identifies which steps are slowing the process down, which steps need improvement, how the steps can be improved, external materials that may be helpful in learning how to improve the steps, and the like.

As one example, a cycle time of a step within the target process may have an expected processing time of 24 seconds as predefined by a user input. During operation of the target process, the actual cycle time of the step may be greater than the expected processing time of 24 seconds. For example, the actual processing time may be 30 seconds. In this case, the system may determine a condition (target cycle time being exceeded) has occurred, and trigger a corresponding action recommendation (e.g., add external users to the workflow, clarify terminology on the form or user interface, etc.) and output the action recommendations.

In some embodiments, the user interface may also display an action button or fix button that allows the user to make a selection and immediately begin modifying the process. In some embodiments, the modifications may be tested against a baseline performance of the process, and the results of the modifications may be made clear by comparing the metrics of the baseline run of the process with a current run of the process with modifications to one or more steps. Therefore, a user can see how their changes affect the cycle time of the individual steps as well as the overall process.

In some embodiments, the determining may include determining a suggestion comprising at least one of removing or changing a position of an approval request within the target process. In some embodiments, the determining may include determining a suggestion to remove an optional parallel process step from the target process based on how often the optional parallel process step is selected. In some embodiments, the determining may include determining a suggestion to change fields within a form that is filled-in during the target process. In some embodiments, the determining may include determining a suggestion to remove one or more fields of the form based on save actions within the user behavior. In some embodiments, the determining may include determining a suggestion to change a step within the target process based on text-based comments created by users of the target process via the user interface.

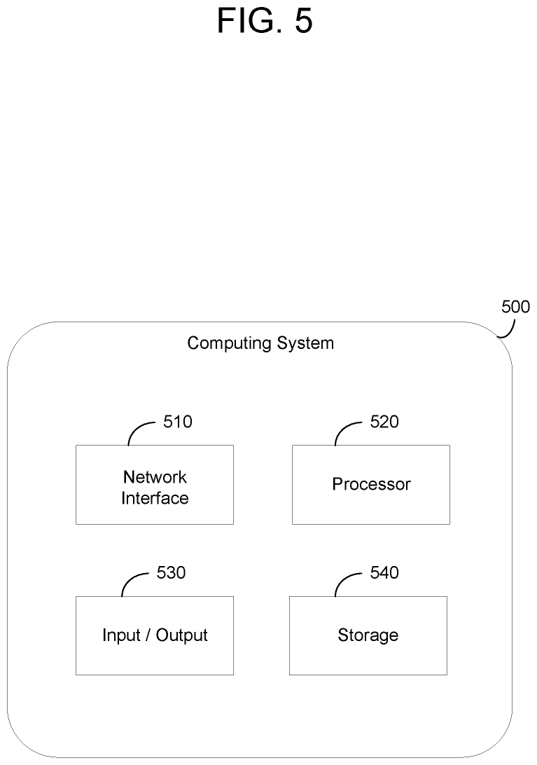

FIG. 5 illustrates a computing system 500 that may be used in any of the methods and processes described herein, in accordance with an example embodiment. For example, the computing system 500 may be a database node, a server, a cloud platform, a user device, or the like. In some embodiments, the computing system 500 may be distributed across multiple computing devices such as multiple database nodes. Referring to FIG. 5, the computing system 500 includes a network interface 510, a processor 520, an input/output 530, and a storage device 540 such as an in-memory storage, and the like. Although not shown in FIG. 5, the computing system 500 may also include or be electronically connected to other components such as a display, an input unit(s), a receiver, a transmitter, a persistent disk, and the like. The processor 520 may control the other components of the computing system 500.

The network interface 510 may transmit and receive data over a network such as the Internet, a private network, a public network, an enterprise network, and the like. The network interface 510 may be a wireless interface, a wired interface, or a combination thereof. The processor 520 may include one or more processing devices each including one or more processing cores. In some examples, the processor 520 is a multicore processor or a plurality of multicore processors. Also, the processor 520 may be fixed or reconfigurable. The input/output 530 may include an interface, a port, a cable, a bus, a board, a wire, and the like, for inputting and outputting data to and from the computing system 500. For example, data may be output to an embedded display of the computing system 500, an externally connected display, a display connected to the cloud, another device, and the like. The network interface 510, the input/output 530, the storage 540, or a combination thereof, may interact with applications executing on other devices.

The storage device 540 is not limited to a particular storage device and may include any known memory device such as RAM, ROM, hard disk, and the like, and may or may not be included within a database system, a cloud environment, a web server, or the like. The storage 540 may store software modules or other instructions which can be executed by the processor 520 to perform the method shown in FIG. 4. According to various embodiments, the storage 540 may include a data store having a plurality of tables, partitions and sub-partitions. The storage 540 may be used to store database objects, records, items, entries, and the like, associated with workflow/process analysis and optimization.

According to various embodiments, the storage 540 may store user behavior of a target process over time, where the user behavior includes actions performed by a user during the target process. For example, the user actions may include requests, selections, etc., that are made or otherwise entered during the target process via a user interface. Examples of user behavior include approval requests (sent to another user), rejections by the system or another user, saves to storage, send backs to another user, forwards (to another user), and the like.

The processor 520 may identify a user behavior within the target process that negatively effects a cycle time needed to complete the target process based on the stored user behavior. For example, the processor 520 may perform metrics on the user behavior data to identify how long each step takes, how many of each of a plurality of different actions are performed within a step over a plurality of cycles, and the like. Based on the metrics, the processor 520 may identify steps that are taking loner than expected. The processor 520 may determine a suggestion to improve the cycle time of the target process based on rules generated from user behavior within other processes, and output a notification of the determined suggestion.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a storage configured to store user behavior of a target process over time, the user behavior comprising actions made during the target process; and
processor configured to
identify a user action within the target process that negatively effects a cycle time needed to complete the target process based on the stored user behavior,
determine a suggestion to improve the cycle time of the target process based on rules generated from user behavior within other processes, and
output a notification of the determined suggestion.

2. The computing system of claim 1, wherein the user behavior comprises one or more of forwards, approvals, denials, saves, and send backs, that are performed by a user within the target process.

3. The computing system of claim 1, wherein the processor is configured to track and store different requests that are entered via a user interface during a plurality of cycles of the target process.

4. The computing system of claim 1, wherein the processor determines a suggestion comprising at least one of removing or changing criteria of an approval request within the target process.

5. The computing system of claim 1, wherein the processor determines a suggestion to remove an optional parallel process step from the target process based on how often the optional parallel process step is selected.

6. The computing system of claim 1, wherein the processor determines a suggestion to change fields within a form that is filled-in during the target process.

7. The computing system of claim 6, wherein the processor determines a suggestion to remove one or more fields of the form based on save actions within the user behavior.

8. The computing system of claim 1, wherein the processor determines a suggestion to change a step within the target process based on text-based comments created by users of the target process via a user interface.

9. A method comprising:
storing user behavior of a target process over time, the user behavior comprising actions made during the target process;
identifying a user action within the target process that negatively effects a cycle time needed to complete the target process based on the stored user behavior;
determining a suggestion to improve the cycle time of the target process based on rules generated from user behavior within other processes; and
outputting a notification of the determined modification.

10. The method of claim 9, wherein the user behavior comprises one or more of forwards, approvals, denials, saves, and send backs, that are performed by a user within the target process.

11. The method of claim 9, wherein the storing comprises tracking different requests that are entered via a user interface during a plurality of cycles of the target process.

12. The method of claim 9, wherein the determining comprises determining a suggestion comprising at least one of removing or changing a position of an approval request within the target process.

13. The method of claim 9, wherein the determining comprises determining a suggestion to remove an optional parallel process step from the target process based on how often the optional parallel process step is selected.

14. The method of claim 9, wherein the determining comprises determining a suggestion to change fields within a form that is filled-in during the target process.

15. The method of claim 14, wherein the determining comprises determining a suggestion to remove one or more fields of the form based on save actions within the user behavior.

16. The method of claim 9, wherein the determining comprises determining a suggestion to change a step within the target process based on text-based comments created by users of the target process via the user interface.

17. A non-transitory computer-readable medium comprising instructions which when executed by a processor cause a computer to perform a method comprising:
storing user behavior of a target process over time, the user behavior comprising actions made during the target process;
identifying a user action within the target process that negatively effects a cycle time needed to complete the target process based on the stored user behavior;
determining a suggestion to improve the cycle time of the target process based on rules generated from user behavior within other processes; and
outputting a notification of the determined modification.

18. The non-transitory computer-readable medium of claim 17, wherein the storing comprises tracking different requests that are entered via a user interface during a plurality of cycles of the target process.

19. The non-transitory computer-readable medium of claim 17, wherein the determining comprises determining a suggestion comprising at least one of removing or changing a position of an approval request within the target process.

20. The non-transitory computer-readable medium of claim 17, wherein the determining comprises determining a suggestion to remove an optional parallel process step from the target process based on how often the optional parallel process step is selected.
